(19) United States
(12) Patent Application Publication
(10) Pub. No.: US 2026/0056740 A1
(43) Pub. Date: Feb. 26, 2026

(54) NON-BLOCKING VECTOR INSTRUCTION DISPATCH WITH MICRO-ELEMENT OPERATIONS

(71) Applicant: Akeana, Inc., Santa Clara, CA (US)

(72) Inventors: Hai Ngoc Nguyen, Redwood City, CA (US); Abhijit Sil, Dublin, CA (US)

(73) Assignee: Akeana, Inc., Santa Clara, CA (US)

(21) Appl. No.: 19/374,321

(22) Filed: Oct. 30, 2025

Related U.S. Application Data
(63) Continuation-in-part of application No. 19/342,743, filed on Sep. 29, 2025.
Application No. 19/342,743 is a continuation-in-part of application No. 19/290,518, filed on Aug. 5, 2025.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.

(51) Int. Cl. G06F 9/30; G06F 9/38

(52) U.S. Cl. CPC G06F 9/30036; G06F 9/30043; G06F 9/3836

(57) ABSTRACT

A processor core is accessed. The processor core is configured to execute vector instructions, scalar instructions, and micro-operations. A vector memory instruction is decoded. The vector memory instruction is associated with a memory addressing mode. The decoding includes replacing the vector memory instruction with one or more vector memory micro-operations (VMMOs). The one or more VMMOs are substituted with one or more vector memory element micro-operations (VMEMOs). The substituting is based on the memory addressing mode. At least one VMEMO within the one or more VMEMOs is forwarded to a memory queue within a plurality of memory queues. A memory operation is issued to a load-store unit within the processor core. The issuing includes selecting, from the plurality of memory queues, the memory operation. The replacing is based on a micro-operation sequencer. One or more destination registers for the vector memory instruction are determined.

### RELATED APPLICATIONS

This application claims the benefit of U.S. provisional patent applications “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, and “Invalidating Snoop Avoidance With Multiple Atomic Loops” Ser. No. 63/899,591, filed Oct. 15, 2025.

This application is also a continuation-in-part of U.S. patent application “Non-Blocking Unit Stride Vector Instruction Dispatch With Micro-Operations” Ser. No. 19/342,743, filed Sep. 29, 2025, which claims the benefit of U.S. provisional patent applications “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, and “In-Order Multithreading With Pipeline Flush And Instruction Replay” Ser. No. 63/870,916, filed Aug. 27, 2025.

The U.S. patent application “Non-Blocking Unit Stride Vector Instruction Dispatch With Micro-Operations” Ser. No. 19/342,743, filed Sep. 29, 2025, is also a continuation-in-part of U.S. patent application “Non-Blocking Vector Instruction Dispatch With Micro-Operations” Ser. No. 19/290,518, filed Aug. 5, 2025, which claims the benefit of U.S. provisional patent applications “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, and “AI Compute Clusters With Noncoherent Shared SRAM” Ser. No. 63/854,877, filed Jul. 31, 2025.

Each of the foregoing applications is hereby incorporated by reference in its entirety.

### FIELD OF ART

This application relates generally to computer processors and more particularly to non-blocking vector instruction dispatch with micro-element operations.

### BACKGROUND

Vector-based mathematics plays an important role in many computer applications, especially in areas where spatial operations, physics simulations, and optimizations are needed. A vector can represent quantities with both magnitude and direction, making it an essential tool for calculations that involve movement, force, and multi-dimensional data. This mathematical framework is used extensively in computer graphics, machine learning, robotics, and scientific simulations. In computer graphics and game development, vectors are used to manipulate objects in 2D or 3D spaces. Operations such as translation, rotation, and scaling rely on vector math to accurately change an object's position or orientation. For example, the movement of characters in games can be implemented by vector transformations, ensuring smooth transitions and realistic physics. Additionally, vectors are instrumental for determining surface appearance in 3D models, which involves computing the way light interacts with objects to enable generation of realistic shading and reflections. Moreover, vectors are essential for rotating objects and assemblies in CAD programs. Each object's position and orientation can be represented as vectors, and transformations such as rotation are applied using mathematical operations. Vectors can be multiplied by a rotation matrix to achieve rotations around specific axes (e.g., X, Y, and Z). In addition, vectors are useful for computations such as computing rotational axes and torques for mechanical assemblies.

Another key area where vectors have utility is in cryptocurrencies. Vectors play a role in blockchain processing, particularly in optimizing performance and cryptographic functions. Blockchain security relies on elliptic curve cryptography (ECC), where vector-based math helps perform operations such as key generation and digital signatures. Moreover, vectorized computations can speed up hashing functions such as SHA-256, essential for mining and block verification. Additionally, vectors help model and manage distributed networks, optimizing routing for peer-to-peer data transfer.

Machine learning and data science benefit from vector operations by representing complex datasets as vectors. Machine learning systems such as support vector machines (SVMs) and neural networks rely on vector spaces to classify data points and optimize performance. In higher-dimensional vector spaces, distance metrics like Euclidean distance help measure similarity between data points, which is foundational for clustering and recommendations. Moreover, in robotic and autonomous systems, vectors can provide computational support for navigation and control. Robots can use vectors to calculate the trajectory of movement, determine velocities, and avoid obstacles in real time. Autonomous vehicles, for example, integrate multiple vectors representing GPS data, sensor input, and planned paths to make split-second driving decisions. These calculations are critical for maintaining precision and safety in dynamic environments. Vector-based operations are also indispensable for simulations. Engineers and scientists use vectors to model forces, velocities, and accelerations, simulating phenomena such as fluid dynamics or mechanical systems. For instance, in computer-aided design (CAD) software, vectors define the positions and orientations of components, enabling precise simulations of stress, strain, and movement.

Thus, vector-based mathematics underpins a vast range of computer applications by enabling efficient manipulation of data, space, and physics. In applications such as gaming, artificial intelligence, robotics, and simulations, vectors offer a way to represent and solve complex problems in multi-dimensional spaces, and enable many other applications.

### SUMMARY

Vector processing is crucial for modern computer applications due to the capability of handling multi-dimensional data efficiently. Vectors enable parallel computations, speeding up tasks such as graphics, machine learning, signal processing, and scientific simulations, to name a few. For graphics, vectors support real-time rendering and 3D transformations in games and CAD software. For machine learning, neural networks rely on vector operations for fast data manipulation and gradient computations. For signal processing, in audio, image, and communication systems, vectors process data streams in parallel. Moreover, complex physical models, such as fluid dynamics, rely on vectors to represent forces and velocities. These, and numerous other applications, benefit from processors that support vector operations.

Techniques for non-blocking vector instruction dispatch with micro-element operations are disclosed. A processor core is accessed. The processor core is configured to execute vector instructions, scalar instructions, and micro-operations. A vector memory instruction is decoded. The vector memory instruction is associated with a memory addressing mode. The decoding includes replacing the vector memory instruction with one or more vector memory micro-operations (VMMOs). The one or more VMMOs are substituted with one or more vector memory element micro-operations (VMEMOs). The substituting is based on the memory addressing mode. At least one VMEMO within the one or more VMEMOs is forwarded to a memory queue within a plurality of memory queues. A memory operation is issued to a load-store unit within the processor core. The issuing includes selecting, from the plurality of memory queues, the memory operation.

A computer-implemented method for vector processing is disclosed comprising: accessing a core, wherein the processor core is configured to execute vector instructions, scalar instructions, and micro-operations; decoding a vector memory instruction, wherein the vector memory instruction is associated with a memory addressing mode, and wherein the decoding includes replacing the vector memory instruction with one or more vector memory micro-operations (VMMOs); substituting the one or more VMMOs with one or more vector memory element micro-operations (VMEMOs), wherein the substituting is based on the memory addressing mode; forwarding at least one VMEMO within the one or more VMEMOs to a memory queue within a plurality of memory queues; and issuing, to a load-store unit within the processor core, a memory operation, wherein the issuing includes selecting, from the plurality of memory queues, the memory operation. In embodiments, the replacing is based on a micro-operation sequencer. Some embodiments comprise determining one or more destination registers for the vector memory instruction. In embodiments, the determining is based on a vector length multiplier (VLM). In embodiments, the memory addressing mode comprises a constant stride addressing mode. In embodiments, the memory addressing mode comprises an indexed stride addressing mode. In embodiments, the substituting includes sending the one or more VMMOs to a vector input queue within a plurality of vector input queues.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for non-blocking vector instruction dispatch with micro-element operations.

FIG. 2 is a flow diagram for issuing a memory instruction.

FIG. 3 is an infographic for non-blocking vector instruction dispatch with micro-element operations.

FIG. 4 is a block diagram of a multicore processor.

FIG. 5 is a block diagram of a pipeline.

FIG. 6 is a block diagram for dispatching instructions.

FIG. 7 is a first example of micro-element dispatch.

FIG. 8 is a second example of micro-element dispatch.

FIG. 9 is a third example of micro-element dispatch.

FIG. 10 is a fourth example of micro-element dispatch.

FIG. 11 is a fifth example of micro-element dispatch.

FIG. 12 is a system diagram for non-blocking vector instruction dispatch with micro-operations.

### DETAILED DESCRIPTION

Disclosed implementations include processors with instruction sets that support vector operations. The dedicated vector instructions enable simultaneous processing of multiple data points, enhancing performance for tasks such as image processing, encryption, and scientific simulations. Moreover, operations on large datasets, such as neural network training or video encoding, can be executed more quickly. Additionally, vector instructions can increase energy efficiency. By handling multiple operations in fewer cycles, processors consume less power. Furthermore, vector instructions can enhance multimedia performance. Tasks involving graphics, audio, and video processing benefit significantly from vector operations. Thus, vector instruction sets are crucial for both high-performance computing as well as everyday multimedia applications.

Pipelining reduces the time needed to execute a sequence of micro-operations by overlapping their execution. This technique allows the processor to begin a new operation before the previous one finishes, improving overall performance. When instruction-level parallelism (ILP) is utilized, multiple operations can progress simultaneously at different stages of execution. Efficient pipelines minimize stalls or bottlenecks, maintaining a smooth flow of operations through the processor. As a result, the processor can consistently perform at or near its maximum capacity, ensuring faster and more efficient program execution.

Processor instruction sets, like those in RISC architectures, can include both scalar and vector operations. Scalar instructions can handle single data points and often use general-purpose registers, typically applied in branching or control tasks. Vector operations, on the other hand, can act on multiple data elements simultaneously, using specialized vector registers to process entire arrays efficiently. This boosts throughput by performing the same operation across data sets with fewer instructions. Advanced vector operations, such as multiplication or dot products, involve multiple steps, including vector alignment, which ensures proper operand preparation based on an addressing mode.

In some implementations, vector operations are executed using hardware components such as dedicated pipelines. Processors leverage vector registers to perform operations on multiple data elements simultaneously, which is ideal for handling large datasets and parallel processing tasks. These registers support operations like element-wise addition, subtraction, multiplication, division, dot products, and shifts. Vector load and store operations are also utilized, enabling efficient movement of data between memory and registers. Disclosed implementations enable a single instruction to perform complex operations across many elements, improving computational efficiency.

Techniques for vector processing are disclosed. Vector instructions are replaced with first-level micro-operations, referred to as vector memory micro-operations (VMMOs). Each VMMO can be substituted with one or more second-level micro-operations, referred to as vector memory element micro-operations (VMEMOs). The substituting can be based on an addressing mode, such as a constant stride mode or an indexed stride mode. The VMEMOs can be forwarded to instruction queues, and then forwarded to execution units, such as a load-store unit, for execution of the micro-operations. By splitting vector instructions into first-level and second-level micro-operations, the dispatch stage of an instruction pipeline can be free to accept additional instructions, thereby improving overall processor performance.

Stalling a processor pipeline introduces significant inefficiencies by halting the flow of instructions, which can reduce overall performance. When a pipeline stall occurs, the processor must wait for data or control dependencies to resolve, leaving some stages idle and wasting valuable clock cycles. The stalling disrupts the benefits of parallelism and delays the completion of subsequent operations. Frequent stalls can cause bottlenecks, increasing program execution time and power consumption. In applications requiring real-time processing, such delays can degrade system responsiveness and performance predictability.

In particular, a mix of scalar and vector instructions can create challenges for maintaining pipeline efficiency. For example, vector instructions can take longer to process than scalar instructions. In a processor pipeline that includes a fetch, align/decode, dispatch, and other downstream units for execution of instructions, a vector instruction could potentially create a bottleneck in the pipeline, stalling subsequent instructions. Disclosed embodiments address the aforementioned issues by implementing a multi-level micro-operation replacement and substitute operation. A vector instruction is replaced by one or more VMMOs. Similarly, each VMMO can be substituted by one or more VMEMOs. The VMEMOs are input to an instruction queue for sending to an execution unit for executing the VMEMOs. By placing the VMEMOs in dedicated vector instruction queues, the dispatch stage is free to accept additional instructions. In this way, exemplary implementations serve to improve overall instruction throughput, thereby enhancing processor performance.

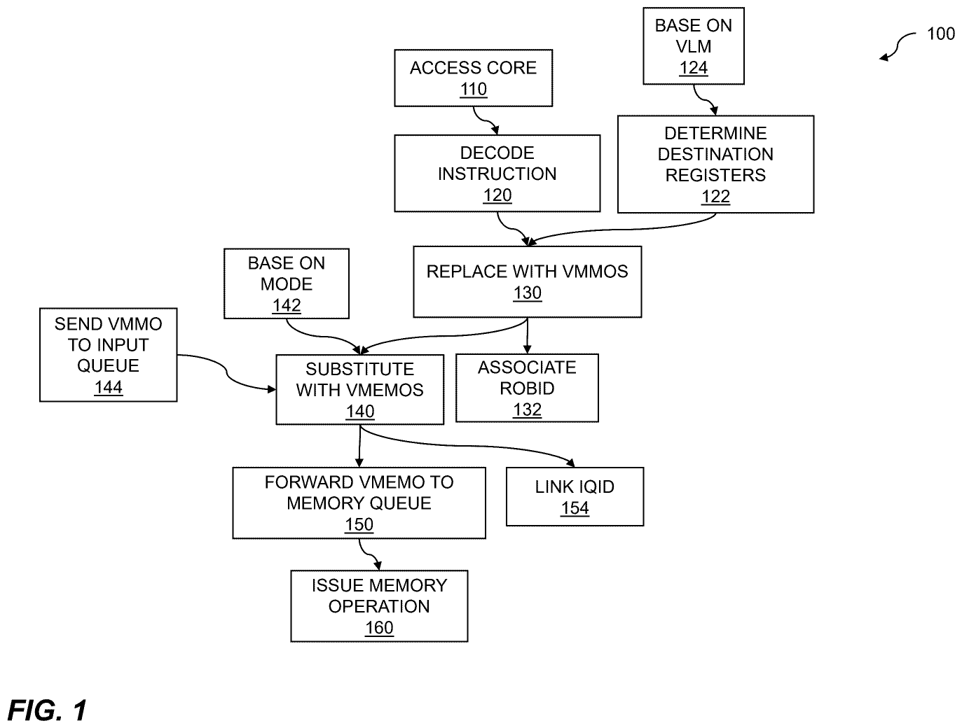

FIG. 1 is a flow diagram for non-blocking vector instruction dispatch with micro-element operations. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as X86, ARM, and so on. The processor core is coupled to a memory hierarchy. The memory hierarchy can include L1, L2, L3, etc. caches. The memory hierarchy can include memory such as DRAM, SDRAM, and so on. The memory hierarchy can be coherent or non-coherent. In embodiments, the processor core is configured to execute vector instructions, scalar instructions, and micro-operations. The micro-operations can comprise a series of instructions that can take the place of a single, more complex instruction. A micro-operation sequencer can be used for vector instructions, scalar instructions, floating point instructions, and so on. Vector instructions can be executed by the processor within a vector pipeline, while scalar instructions can be executed by a scalar pipeline. In some cases, instructions can be executed in different pipelines.

The vector instructions can include vector load instructions and vector store instructions. The vector load instructions and vector store instructions can have a unit stride memory addressing mode which can be executed in a scalar load pipeline. Other access modes, such as indexed stride and/or constant stride, can create numerous noncontiguous memory accesses, which can be intensive to process. Disclosed implementations can decompose vector instructions for constant stride and indexed stride into multiple micro-operations that can be routed to a dedicated vector instruction queue, thereby improving the availability of a dispatch unit within the pipeline for processing subsequent instructions. In one or more embodiments, the memory addressing mode comprises a constant stride addressing mode. In one or more embodiments, the memory addressing mode comprises an indexed stride addressing mode.

The flow 100 continues with decoding an instruction 120. The instruction can include a scalar instruction and/or a vector instruction. The decoding can include identifying opcodes, operands, control signals, and the like. The vector memory instruction or operation can include an instruction for data movement. Data movement instructions can include load and/or store operations for transferring data between memory and registers. The vector memory operation can include a vector load operation. The vector memory operation can include a vector store operation. The registers can include scalar registers and vector registers. The sizes of scalars supported by the instruction and the sizes of vectors supported by the instruction can vary. The vector sizes supported by the instructions can include any number of bits such as 8 bits, 16 bits, 32 bits, 64 bits, and so on. The decoding can be accomplished by a decode unit and/or a decode stage within a processor core. In embodiments, the vector memory instruction is associated with a memory addressing mode. The addressing mode can include a unit stride addressing mode, in which contiguous memory is transferred to or from a vector register. The addressing mode can include a constant stride addressing mode, in which a stride is specified in a vector instruction and/or one or more control status registers (CSRs). For example, a constant stride of 1024 bytes for a vector load instruction can indicate that data elements being loaded from memory are spaced 1024 bytes apart. This means the instruction accesses memory locations with a fixed interval or “stride” between consecutive elements, which is useful for loading structured data, like arrays or matrices, efficiently. This pattern is common in scientific computing or graphics, where data can be arranged in predictable layouts. Similarly, the addressing stride can include an indexed stride addressing mode, in which a stride is specified in a register. The stride may be changed by changing the value in that register. An indexed stride can operate similarly to a constant stride, but with the additional flexibility of being able to change the stride by changing the value in the designated register.

The flow 100 includes determining destination registers 122. Embodiments include determining one or more destination registers for the vector memory instruction. The destination registers can include registers where the result of an operation is stored. The operation can include a load operation, arithmetic operation, logic operation, and/or other types of data movement operations. In exemplary implementations, for vector operations, a destination vector register can store the result of operations across multiple data elements processed simultaneously. The determining can be based on a vector length multiplier (VLM) 124. Thus, in embodiments, the determining is based on a vector length multiplier (VLM). In exemplary implementations, the VLM can control how the vector register width is scaled based on a given operation. The VLM setting allows for flexible vector lengths, helping optimize processing performance based on the workload and available hardware resources. In exemplary implementations, the VLM setting adjusts the number of registers used in a vector operation. In exemplary implementations, an architectural vector register (e.g., V1 in RISC-V) may use more than one physical register depending on the VLM setting. By adjusting the VLM value, the vector register file can accommodate more data per operation, enabling wider vector operations. Thus, the VLM value can control a number of source and destination registers used by the vector instruction. The VLM value can be combined with other values (for example, vector element width, the width of the registers in the vector register file, and so on) to determine a final number of source and destination registers used. This information can be used to determine a number of VMMOs required. The number of VMMOs used to replace the vector memory instruction (explained below) can be based on the number of destination registers determined.

The flow 100 continues with replacing the decoded instruction with VMMOs 130. Thus, in embodiments, the decoding includes replacing the vector memory instruction with one or more vector memory micro-operations (VMMOs). In embodiments, the replacing is based on a micro-operation sequencer. In exemplary implementations, the micro-operation sequencer can generate a series of micro-operations based on an input vector memory instruction. Concurrently, scalar memory operations can be routed to respective scalar load queues and/or scalar store queues. The VMMOs can include load instructions for transferring contents to registers from memory. The VMMOs can include store instructions for transferring contents to memory from registers. The VMMOs can be implemented as first-level micro-operations. For load operations, the VMMOs can include an element width, an operand that specifies a destination vector register where the data elements are loaded to, an operand that specifies a base address from which the load operation will begin, an operand that contains a stride value, determining the distance (in bytes) between consecutive elements in memory, and so on.

The flow 100 includes associating a VMMO with a reorder buffer (ROB) identification (ROBID) 132. The ROBID can be associated with a vector instruction, a scalar operation, one or more micro-operations, one or more vector element micro-operations, and so on. An older instruction can be indicated by a lower ROBID. Choosing an instruction can be accomplished with one or more multiplexers (muxes). The muxes can be controlled with a control signal that is based on an instruction type associated with a lowest ROBID value. In disclosed examples, the instruction associated with the lowest ROBID is the oldest instruction, and is the instruction that can be issued first. The issued instruction can load or store scalar data or vector data. In exemplary implementations, the ROBID indicates an oldest instruction within the plurality of memory queues. In one or more examples, rollover logic can be implemented to handle the case of the counter rolling over, thereby enabling continuation of proper instruction operation. The rollover logic can include detection, where the ROBID value can be monitored for overflow or underflow. In other implementations, the ROBID can include a wrap bit.

The flow 100 includes substituting a VMMO with one or more VMEMOs 140. The VMEMOs can comprise second-level micro-operations. A VMMO can be split into one or more VMEMOs, which can be multiple lower-level micro-operations. The substituting can be based on the memory addressing mode 142. The memory addressing mode can include an indexed stride mode, and/or a constant stride mode. Strided data loading is useful when accessing noncontiguous memory locations efficiently, and can enable scientific computing, graphics, and signal processing applications, among others. In particular, strided data accesses are beneficial when processing multi-dimensional arrays (e.g., columns of a matrix) or structured data layouts, where elements are not stored consecutively in memory. However, accessing strided data with a single instruction can be complex. Instead, VMEMOs can be used to load or store each vector element at the various addresses indicated in the strided memory access. The number of VMEMOs used in the substituting can be based on the number of vector elements involved in the strided access.

The flow 100 includes sending the VMMO to an input queue 144. In exemplary implementations, the VMMOs are substituted with VMEMOs after they are sent to input queues for loads and stores respectively. In embodiments, the substituting includes sending the one or more VMMOs to a vector input queue within a plurality of vector input queues. In embodiments, the substituting is accomplished by a vector element micro sequencer. Ther vector element micro sequencer can be based on a state machine, lookup table, or another design structure. The processor can include multiple input queues. For example, a vector load input queue (VLIQ) can be reserved for VMMOs stemming from a vector load instruction. Similarly, a vector store input queue (VSIQ) can be reserved for VMMOs stemming from a vector store instruction. More or fewer vector input queues can be included. In embodiments, the vector element micro sequencer is located in the vector input queue.

The flow 100 includes forwarding at least one VMEMO within the one or more VMEMOs to a memory queue 150 within a plurality of memory queues. In exemplary implementations, the VMEMO can include one or more micro-operations for a load instruction or a store instruction. The flow 100 further includes linking an input queue ID (IQID) 154. Embodiments include linking an input queue ID (IQID) with the one or more VMEMOs. In exemplary implementations, the IQID can indicate an entry within a ROB. The IQID can be used to track the status of each VMEMO as it is executed so that the group of VMEMOs associated with a VMMO can be retired at the same time within the ROB. The IQID can be utilized to track a VMEMO micro-operation to ensure that corresponding entries are not freed from the ROB until the corresponding VMMO operation has completed. The flow 100 continues with issuing a memory operation 160. The memory operation can include a load operation, where one or more vector element values are transferred from memory to corresponding locations within a vector register. The memory operation can include a store operation, where one or more vector element values are transferred from vector element locations within a vector register to memory. In exemplary implementations, the transferring can be based on a stride addressing mode, such as a unit stride, constant stride, and/or indexed stride addressing mode.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

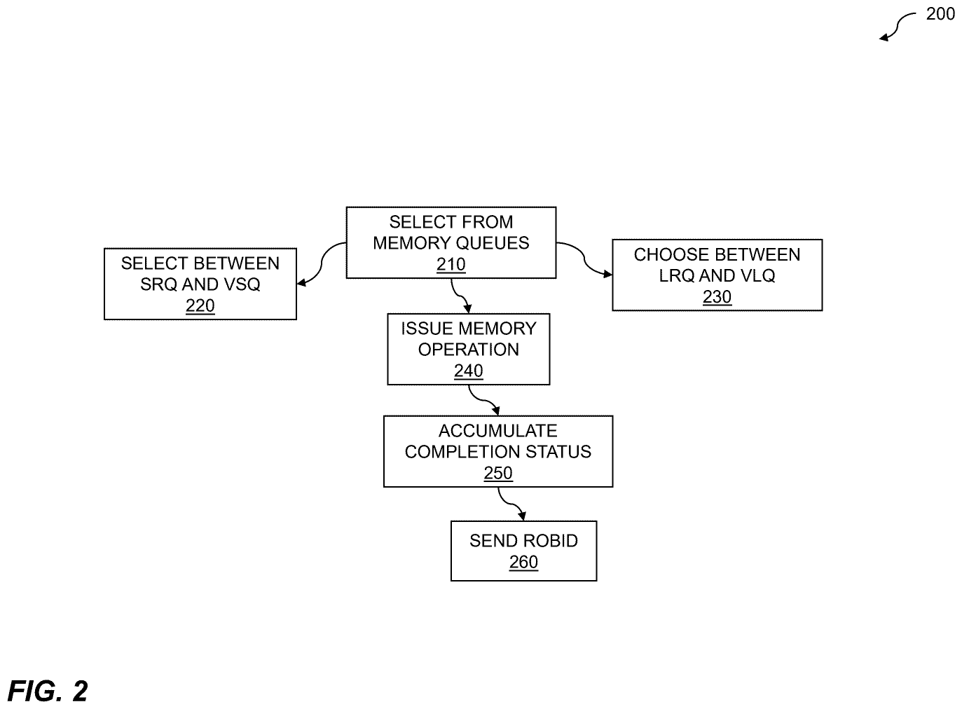

FIG. 2 is a flow diagram for issuing a memory instruction. In the flow 200, issuing a memory instruction can include selecting the memory instruction from a plurality of memory queues 210. The processor can include memory queues for scalar load instructions, vector load instructions, scalar store instructions, vector store instructions, and so on. The processor can select a store operation between a scalar store instruction and a vector store instruction (such as a VMEMO) to be sent into an execution pipeline such as within a load-store unit (LSU). Likewise, the processor can select between a load operation, a scalar load instruction, and a vector load instruction (such as a VMEMO) to be sent to an LSU. In exemplary implementations, the ROBID can be used as a criterion for configuring a multiplexor (mux) to select the proper queue for a scalar or vector instruction to maintain proper execution of each instruction while preserving a correct instruction retirement order and enabling out-of-order execution.

Recall that a vector memory instruction can be replaced with one or more VMMOs. Recall also that the one or more VMMOs can be substituted with one or more VMEMOs. In embodiments, the vector memory instruction comprises a vector store instruction. The substituting a VMMO for one or more VMEMOs can take place within an input queue within a plurality of input queues. When the vector memory instruction is a vector store instruction, the input queue can be a vector store input queue. In embodiments, the vector input queue comprises a vector store input queue (VSIQ). Recall that at least one VMEMO can be sent to a memory queue within a plurality of memory queues. The memory queue can hold a VMEMO ready to be issued to an execution pipeline. The execution pipeline can be based on a load-store unit (LSU). In embodiments, the memory queue comprises a vector store queue (VSQ). Scalar memory queues can also be included so that scalar store instructions and vector store instructions, which can be decomposed into at least one VMEMO, can be buffered separately. In embodiments, the plurality of memory queues includes a scalar store request queue (SRQ). As shown in the flow 200, the processor can select an instruction to issue from the SRQ and the VSQ 220. In embodiments, the selecting comprises selecting between a scalar store instruction within the SRQ and the at least one VMEMO, within the VSQ. In further embodiments, the selecting is based on a reorder buffer identification (ROBID). In embodiments, the ROBID indicates an oldest entry within the plurality of memory queues. Thus, the processor can decide to issue the oldest entry between a VMEMO in the VSQ or a scalar store instruction within the SRQ.

The process described above can be mirrored when the vector memory instruction is a load instruction. In embodiments, the vector memory instruction comprises a vector load instruction. Recall that the substituting a VMMO for one or more VMEMOs can take place within an input queue within a plurality of input queues. When the vector memory instruction is a vector load instruction, the input queue can be a vector load input queue. In embodiments, the vector input queue comprises a vector load input queue (VLIQ). At least one VMEMO can be sent to a memory queue within a plurality of memory queues. The memory queue can hold a VMEMO ready to be issued to an execution pipeline such as an LSU. In embodiments, the memory queue comprises a vector load queue (VLQ). Scalar memory queues can also be included so that scalar load instructions and vector load instructions, which can be decomposed into at least one VMEMO, can be buffered separately. In embodiments, the plurality of memory queues includes a scalar load request queue (LRQ). As shown in the flow 200, the processor can select an instruction to issue from the LRQ and the VLQ 230. In embodiments, the selecting comprises selecting between a scalar load instruction within the LRQ and the at least one VMEMO within the VLQ. In further embodiments, the selecting is based on a reorder buffer identification (ROBID). In embodiments, the ROBID indicates an oldest entry within the plurality of memory queues. Thus, the processor can decide to issue the oldest entry between a VMEMO in the VLQ or a scalar load instruction within the LRQ.

The flow 200 further includes issuing a memory operation 240. The memory operation can include a scalar operation. The memory operation can include a vector operation. The vector operation can have a stride mode associated with it. The stride mode can include a unit stride, constant stride, indexed stride, and/or other stride mode. The scalar and vector operations can include data movement operations such as load operations and store operations. The scalar and vector operations can include other operations, such as arithmetic operations, logical operations, branching operations, and so on. The processor can issue the instruction that was selected to one or more LSUs for execution.

The flow 200 includes accumulating a completion status 250. Embodiments can include accumulating a completion status of the at least one VMEMO, wherein the accumulating is based on the input queue ID. Properly recording and indicating the completion status of an operation in a pipelined processor can be required for maintaining correct execution and maximizing performance. Since a pipelined processor can overlap the execution of multiple instructions (for example, by dividing them into stages), tracking the completion of each operation can ensure data consistency, prevent hazards, and avoid bottlenecks. If the completion status of operations is not correctly recorded, subsequent instructions might proceed with incorrect or incomplete data. As an example, in the case of a vector load instruction, if a dependent instruction reads a vector register before the load instruction is indicated as complete, the dependent instruction may operate on incorrect values. Exemplary implementations utilize the input queue identifier (IQID) to ensure the completion status of a given architectural vector instruction is accurately indicated. In exemplary implementations, the IQID can serve as a group identifier, to identify a group of VMEMOs as corresponding to a given VMMO. In exemplary implementations, the ROBID may also have a 1:1 correspondence to the IQID. Accordingly, one or more embodiments can include associating a reorder buffer ID (ROBID) with the one or more VMMOs. The flow 200 further includes sending a ROBID 260. Embodiments can include sending, to a reorder buffer, the ROBID that was associated, wherein the sending is based on a completion of the one or more VMEMOs. In response, the ROB can free the slot corresponding to the ROBID that was associated, thereby vacating a slot for another subsequent instruction to enter the dispatch stage of an instruction pipeline.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

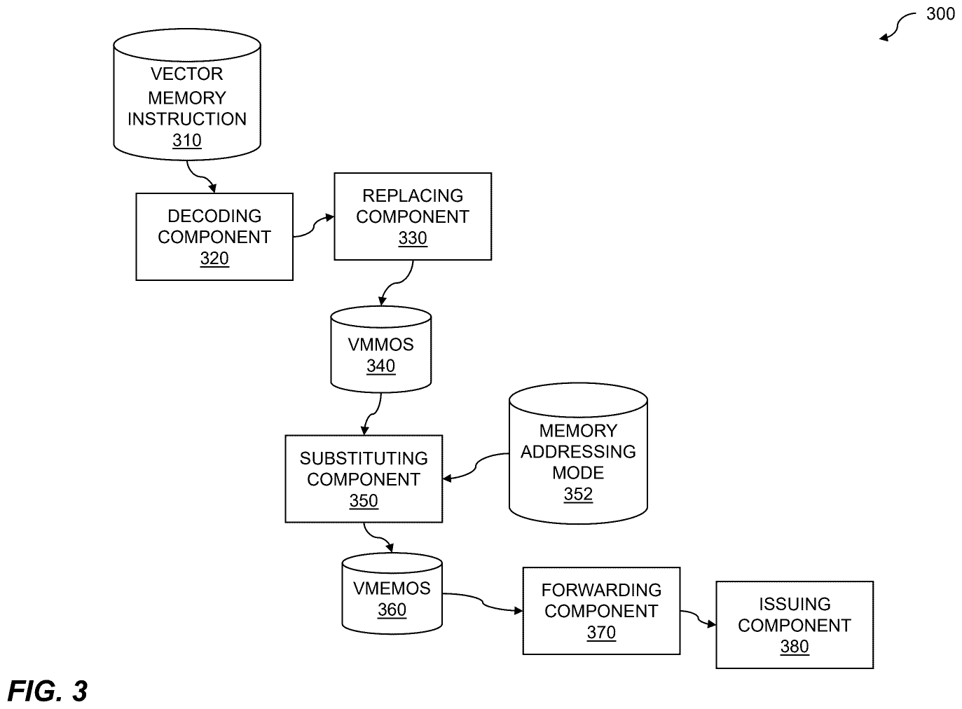

FIG. 3 is an infographic for non-blocking vector instruction dispatch with micro-element operations. In the infographic 300, a vector memory instruction 310 can include a vector load instruction and/or a vector store instruction. The vector memory instruction can include a stride mode associated with it. In exemplary implementations, the stride mode can be implied by an opcode value or instruction mnemonic, specified as an operand within the vector memory instruction, and/or specified by one or more bits within a control status register (CSR). The stride mode can include a unit stride, constant stride, indexed stride, and/or other suitable stride mode. In exemplary implementations, a unit stride is a special case of a constant stride in which the constant stride is set to a value of 1, indicating vector memory operations utilizing contiguous memory. In embodiments, the vector memory instruction comprises a vector load instruction. The vector memory instruction 310 is input to decoding component 320. The decoding component can include functions and instructions for determining an instruction type. The type can include one of a scalar instruction type and/or a vector instruction type. Additionally, the decoding component can, based on opcodes, operands, and/or control status register settings, determine a category of an instruction as a memory operation, such as a load operation or store operation. For vector memory operations, the high-level architectural instructions are input to replacing component 330. For example, the RISC-V instruction VLSE64. V R1, R2 is a high-level, architectural instruction that is part of the RISC-V Vector Extension (RVV) which performs a vector load with a specific stride. The replacing component 330 can decompose a high-level architectural instruction into one or more VMMOs 340. The VMMOs can each represent a first-level micro-operation. As described above, the number of VMMOs can be based on the number of destination registers required by the instruction, a vector length multiplier, and/or other controls. In exemplary implementations, a vector register corresponding to a high-level architectural instruction can utilize one or more physical registers. In exemplary implementations, each VMMO that corresponds to a high-level architectural instruction may operate on a distinct physical vector register.

Each VMMO can be input to substituting component 350. The substituting component 350 can receive, as input, a memory addressing mode 352. The memory addressing mode can include a stride mode. In exemplary implementations, the stride mode can include a unit stride, constant stride, indexed stride, and/or other corresponding stride mode. An indexed stride can include a stride in which the stride value is based on a register setting. In exemplary implementations, the stride mode can include a dynamic-stride mode. The dynamic-stride mode can enable support for gather-scatter instructions that can operate with noncontiguous data structures such as sparse matrices, graphs, and multi-dimensional datasets. When the memory addressing mode is in a constant stride or indexed stride addressing mode 352, the substituting component 350 decomposes each VMMO into one or more VMEMOs 360. Each VMEMO can be a second-level micro-operation. As described earlier, the number of VMEMOs can be based on a number of vector elements associated with the strided memory access. Each VMEMO is then provided to a forwarding component 370, which can include one or more queues. The queues can store the VMEMOs corresponding to a given high-level architectural instruction. An identifier, such as a ROBID and/or IQID, can be used to indicate each VMEMO that is associated with a given high-level architectural instruction. The VMEMO is then provided to issuing component 380. The issuing component that is selected or chosen can be based on an operation type and/or instruction type. As an example, memory micro-operations can be forwarded to an issuing component that includes a load/store execution unit.

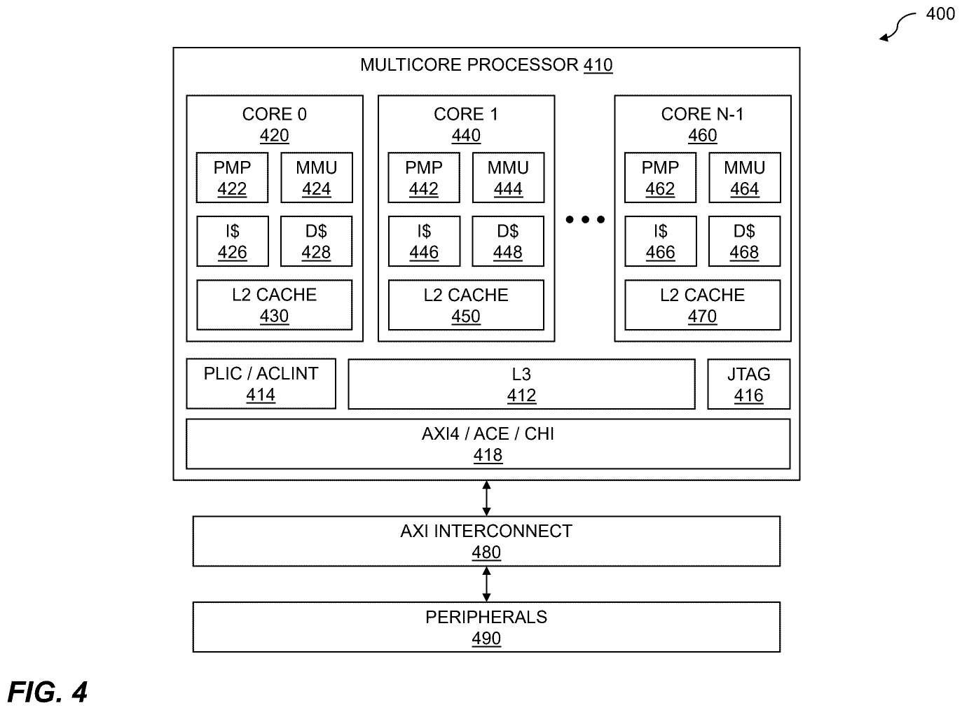

FIG. 4 is a block diagram of a multicore processor. The processor, such as a RISC-V™ processor, an ARM processor, or other suitable processor type, can include a variety of elements. The elements can include processor cores including multiprocessor cores, one or more caches including local caches and shared caches, memory protection and management units, local storage, and so on. The elements of the multicore processor can further include one or more of a private cache; a test interface such as a joint test action group (JTAG) test interface; one or more interfaces to a network such as a network-on-chip, shared memory, and peripherals; and the like. A processor core is accessed, wherein the processor core is coupled to a memory hierarchy, and wherein the processor core is configured to execute vector operations, scalar operations, and micro-operations. A decode unit decodes a vector memory operation, wherein the vector memory operation is associated with an addressing mode, such as a unit stride, constant stride, indexed stride, and/or other suitable stride mode. The decoding includes dividing the vector memory operation into one or more vector memory micro-operations. A dispatch unit sends at least one vector micro-operation, within the one or more vector micro-operations, to a scalar request queue within a plurality of request queues. A load-store unit within the processor core issues the at least one vector micro-operation, wherein the issuing includes selecting, from the plurality of request queues, the at least one vector memory micro-operation. The micro-operations can be first-level micro-operations that are further decomposed into second-level micro-operations.

In the block diagram 400, the multicore processor 410 can comprise two or more processors, where the two or more processors can include homogeneous processors, heterogeneous processors, etc. In the block diagram, the multicore processor can include N processor cores such as core 0 420, core 1 440, core N−1 460, and so on. Each processor can comprise one or more elements. In one or more implementations, each core, including cores 0 through core N−1, can include a physical memory protection (PMP) element, such as PMP 422 for core 0; PMP 442 for core 1, and PMP 462 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N−1. The memory management units can translate virtual addresses used by software running on the cores to physical memory addresses within caches, the shared memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N−1. In addition to the level 1 instruction and data caches, each core can include a level 2 (L2) cache. The level 2 caches can include L2 cache 430 associated with core 0; L2 cache 450 associated with core 1; and L2 cache 470 associated with core N−1. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces including an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™ interconnect 480. In one or more implementations, the network can include network-on-chip functionality. The AXI™ interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

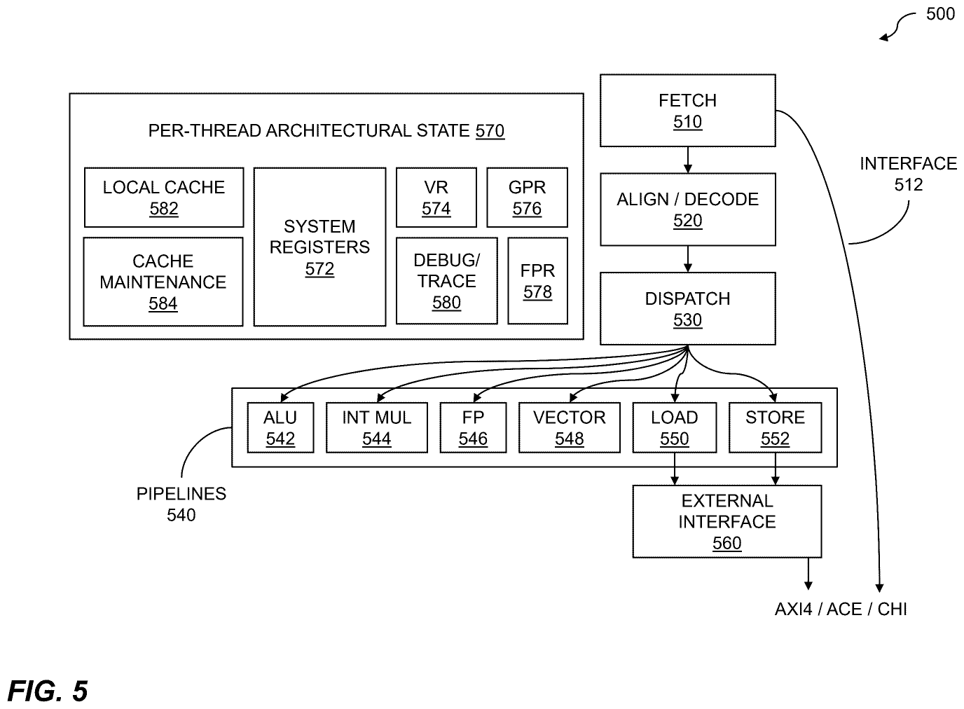

FIG. 5 is a block diagram of a pipeline. One or more pipelines associated with a processor architecture can be used to greatly enhance processing throughput. The processor architecture can be associated with one or more processor cores. The processing throughput can be increased because multiple operations can be executed in parallel. In one or more implementations, a processor core is accessed. The processor core is coupled to a memory hierarchy, and the processor core is configured to execute vector operations, scalar operations, and vector load micro-operations and vector store micro-operations. A decode unit decodes a vector memory operation, where the vector memory operation is associated with a stride addressing mode, such as unit stride, constant stride, indexed stride, or other suitable stride addressing mode. The decoding includes dividing the vector memory operation into one or more vector memory micro-operations. In exemplary implementations, vector memory micro-operations can be further decomposed into second-level vector memory micro-operations.

The blocks within the block diagram can be configurable in order to provide varying processing levels. The varying processing levels can be based on processing speed, bit lengths, word lengths, numbers of micro-operations, and so on. The block diagram 500 can include a fetch block 510. The fetch block 510 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 500 can include a dispatch block 530. The dispatch block can receive decoded instruction packets from the align and decode block. The decoded instruction packets can be used to control a pipeline 540, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipelines that can include load pipelines 550, and store pipelines 552. The load pipelines and the store pipelines can access storage such as the common memory using an external interface 560. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 570. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VRs) 574. The vector registers can be grouped in a vector register file and can be used for vector operations. In one or more exemplary implementations, the width of the vector register file is 512 bits. Additional registers, such as general-purpose registers (GPRs) 576 and floating-point registers (FPRs) 578, can be included. These registers can be used for general purpose (e.g., integer) operations, and floating-point operations, respectively. The per-thread architectural state can include a debug and trace block 580. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 582. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 584. The cache maintenance state can include maintenance needed, maintenance pending, and maintenance complete states, etc.

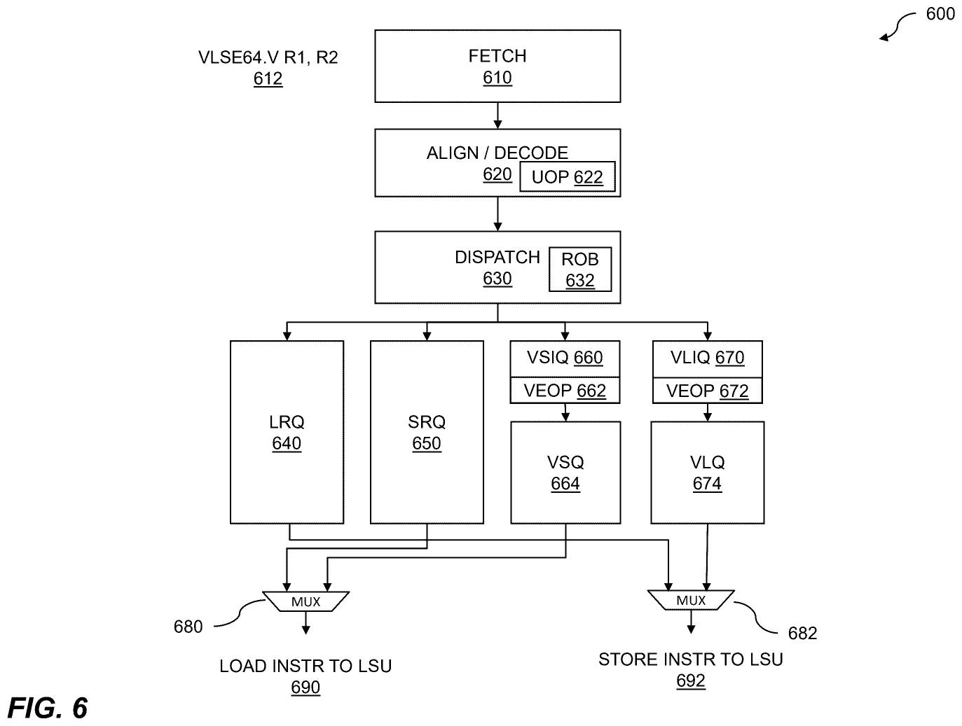

FIG. 6 is a block diagram for dispatching instructions. Instructions such as vector memory instructions based on one or more stride addressing modes, scalar memory instructions, and so on can be fetched from storage. The vector memory instructions can include vector memory instructions based on an indexed stride or a constant stride. The instructions can be decoded. Vector memory instructions that are based on a stride addressing mode can be divided into one or more micro-operations. The micro-operations can be sent by a dispatch unit to a vector load input queue, vector store input queue, or other suitable input queue. The micro-operations can be issued to a load-store unit, where the load-store unit can handle memory access operations such as memory load operations and memory store operations. The dispatching of instructions enables non-blocking vector memory instruction dispatch with micro-operations. In exemplary implementations, micro-operations can be further decomposed into second-level micro-operations. The vector memory instructions can include instructions with unit stride, constant stride, indexed stride, and/or other stride addressing modes.

The block diagram 600 includes a fetch unit 610. In one or more examples, the fetch unit can perform functions such as retrieving the next instruction from memory based on a program counter (PC). The fetch unit may also perform functions that include incrementing the PC to point to the next instruction. In one or more examples, the fetch unit can also participate in branch prediction to improve instruction flow efficiency. The fetch unit can prefetch instructions that are deemed likely to be executed. Additionally, the fetch unit can interact with one or more instruction caches to reduce latency when fetching instructions. In one or more examples, the fetch unit may be similar to fetch block 510 shown in FIG. 5. Once instructions are fetched, the instructions are provided to the align/decode unit 620. The align/decode unit may perform functions that include aligning instruction boundaries to ensure proper processing. The decoding by the align/decode unit can include dividing an instruction such as a vector memory instruction based on a stride addressing mode into one or more vector memory micro-operations (VMMOs). This can be accomplished by a micro-operation sequencer 622. The micro-operation sequencer can determine the number of VMMOs required by resolving the number of destination registers required by the instruction and/or one or more control registers. Additionally, the align/decode unit can perform operations of translating binary instruction codes into control signals and fields needed for execution, and also identifying and retrieving operands from registers based on the instruction. The operands can include, but are not limited to, register operands, immediate operands (to support constants embedded directly within the instruction), memory operands, PC-relative operands (addresses calculated relative to the current value of the program counter, often used for branching), indexed operands, and/or other types of operands. In one or more examples, the align/decode unit may be similar to the align/decode block 520 shown in FIG. 5.

The scalar instructions and the micro-operations can be provided to the dispatch unit 630. In one or more examples, the dispatch unit can perform functions that include sending at least one vector micro-operation, within the one or more vector micro-operations, to a scalar request queue within a plurality of request queues. The dispatch unit can include a reorder buffer (ROB) 632. In one or more examples, the ROB can keep track of the order of micro-operations as they are issued and executed out of order. The ROB can enable proper micro-operations retirement by ensuring that micro-operations such as memory loads and memory stores are completed and that the loads and the stores are performed in the correct program order. The ROB can include multiple entries, where each entry corresponds to an instruction in the dispatch unit. A reorder buffer identification (ROBID) can refer to an entry in the ROB.

Based on the instruction type, such as a vector operation or a scalar operation, the dispatch unit can send one or more vector memory micro-operations (VMMOs) to one of various queues for further processing. Recall that the dispatch unit can send one or more VMMOs based on an indexed stride or a constant stride to a first vector input queue. When the vector operation is a load, the first vector input queue can comprise a vector load input queue (VLIQ) 670. Thus, in embodiments, the vector input queue comprises a vector load input queue (VLIQ). The vector element micro-operation sequencer 662 within the VLIQ can substitute one or more vector load micro-operations with one or more vector element load micro-operations (VMEMOs). In embodiments, the substituting is accomplished by a vector element micro sequencer. The vector element micro-sequencer can determine the number of VMEMOs required by resolving the number of vector elements required by each VMMO. The micro-sequencer can use one or more control registers to determine the number of VMEMOs required. The one or more vector element load micro-operations can then be chosen to be sent to an LSU for execution. In embodiments, the vector element micro sequencer is located in the vector input queue. The above can also apply to a vector store instruction. When the vector operation is a store operation, the first vector input queue can comprise a vector store input queue (VSIQ) 660. In embodiments, the vector memory instruction comprises a vector store instruction. The vector element micro-operation sequencer 672 within the VSIQ can split each of the one or more vector store micro-operations into one or more vector memory element store micro-operations. In embodiments, the vector input queue comprises a vector store input queue (VSIQ). The one or more vector element store micro-operations can then be chosen to be sent to an LSU for execution.

In one or more examples, the vector element micro-operation sequencer (whether within the VLIQ or the VSIQ) can be implemented as a finite state machine, which takes inputs that can include a type register, a source register, and/or a destination register. The vector element micro-operation sequencer logic can ensure that it increments source register(s), destination register(s), element numbers, and so on as per requirement of the processor vector specification when it breaks the instruction into individual vector element micro-operations. The processor vector specification can include RISC-V, X86, ARM, or another vector specification. In one or more examples, the splitting, the executing, and the determining are performed by a micro-operation sequencer that is separate from a dispatch unit of the processor core. An important benefit of the vector instruction input queues (VLIQ and VSIQ) is that they obviate the need for the dispatch unit to further split vector micro-operations into additional vector element micro-operations, which could potentially cause stalls in execution of other instructions waiting to be dispatched, such as a scalar load, scalar store, or another vector memory operation or micro-operation.

Recall that the processor can include a plurality of memory queues. The memory queues can send instructions to a mux which can select between queue outputs. The output of the mux can be sent directly to an execution unit, such as a load-store unit (LSU). The LRQ 640 can process scalar load instructions, micro-operations divided from vector load operations based on a stride addressing mode, etc. The SRQ 650 can process scalar store instructions and vector store micro-operations divided from vector store operations based on a stride addressing mode. In embodiments, the plurality of memory queues includes a scalar store request queue (SRQ). In exemplary implementations, the plurality of memory queues includes a vector load queue (VLQ) 674 and vector store queue (VSQ) 664. The VLQ can process vector load element micro-operations divided from vector load micro-operations based on an index stride, constant stride, etc. In embodiments, the selecting comprises selecting between a scalar store instruction within the SRQ and the at least one VMEMO within the VSQ. The VSQ can process vector store element micro-operations divided from vector store micro-operations based on an index stride, constant stride, etc. In embodiments, the memory queue comprises a vector store queue (VSQ).

With the above structure, a load operation can be selected from the LRQ or the VLQ using a mux and can be sent to the load-store unit for execution. Likewise, a store operation can be selected from the SRQ or the VSQ using a mux and can be sent to the load-store unit for execution. The load operations and store operations are routed to respective muxes. In one or more exemplary implementations, the muxes may be operated by selecting one of two input signals to pass through to the output based on a control signal. Thus, the multiplexers route one of the two inputs to the output depending on the value of the control signal, enabling flexible data routing for scalar and vector memory instructions in exemplary implementations.

The load operations (both scalar and vector) are routed to mux 680. Similarly, the store operations (both scalar and vector) are routed to mux 682. The muxes pass instructions to respective load store units. Mux 680 is configured to select between scalar load instructions from LRQ 640 and vector load instructions from VLQ 674. The output of the mux 680 is sent to a load-store unit 690. Similarly, mux 682 is configured to select between scalar store instructions from SRQ 650 and vector store instructions from VSQ 664. The output of the mux 682 can be sent to a load-store unit. The ROBID can be used as a criterion for configuring the muxes to select the proper scalar or vector instruction to issue an oldest instruction to an execution pipeline. Mux 680 can be configured to provide the proper load instruction to load-store unit 690 based on the ROBID. Similarly, mux 682 can be configured to provide the proper load instruction to load store unit 692 based on the ROBID.

The vector instruction 612 is in fetch unit 610. The vector instruction 612 (VLSE64. V R1, R2) has a mnemonic VLSE, which indicates Vector Load Strided Elements. This operation loads multiple data elements into a vector register, with each element spaced apart by a stride. The “64” suffix indicates that each element being loaded is 64 bits wide (i.e., 8 bytes). Accordingly, the vector register is filled with 64-bit elements upon successful execution/completion of the instruction. Register R1 is a base address register, which holds the starting memory address for the load. Register R2 contains the stride value, indicating the number of bytes between consecutive elements being loaded from memory

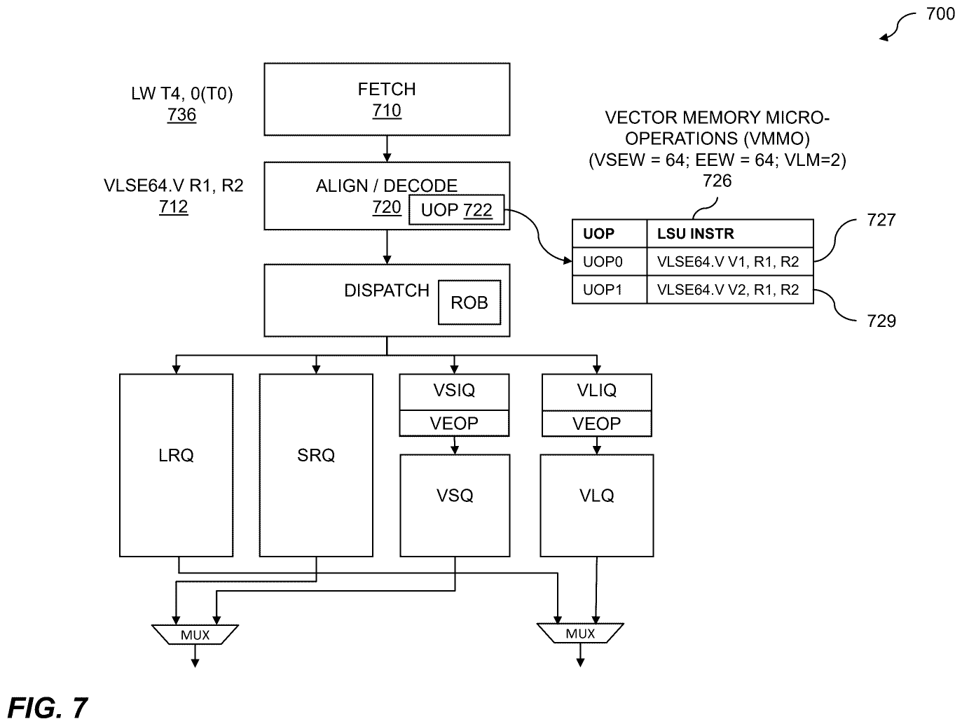

FIG. 7 is a first example of micro-element dispatch. The example 700 is based on the block diagram for dispatching instructions shown in FIG. 6 and described previously. Accordingly, components in FIG. 7 are similar to counterpart components shown in FIG. 6. As shown in the example 700, a vector instruction 712 is in the align/decode unit 720. A subsequent instruction is scalar instruction 736. The scalar instruction is shown in the fetch unit 710. The scalar instruction 736 (LW T4, 0(T0)) has a mnemonic LW, which indicates a load word operation. This operation loads a word into destination register T0. The 0(T0) operand refers to a memory address, and indicates that the value to be loaded is from the address computed by adding an offset 0f 0 to the value stored in register T0.

Referring again to vector instruction 712, in the align/decode unit 720, a micro-operation sequencer 722 decomposes vector instruction 712 into multiple first-level micro-operations, referred to as vector memory micro-operations (VMMOs). The number of first-level micro-operations that are used can be based on a value of the vector length multiplier (VLM), a vector standard element width (VSEW), an effective element width (EEW), and/or other values. In a RISC-V processor with vector extensions (RVV), the values for the VSEW (Vector Standard Element Width) and EEW (Effective Element Width) fields impact how data is processed and stored by vector instructions. The VSEW field can specify the element width for vector instructions specified by the processor configuration and/or instruction set. The VSEW can define the size of the elements within the vector registers for operations. Exemplary implementations can include widths of 8, 16, 32, and/or 64 bits, corresponding to different data types (e.g., byte, half-word, word, and double-word). As an example, a VSEW having a value of 32 indicates that each element of the vector operation is 32 bits (one word), meaning the vector register will treat its content as multiple 32-bit elements. The VSEW can serve to establish consistent element sizes during vector operations and enable aligning of vector instructions to application requirements, such as using smaller widths for operations on byte-level data or larger widths for floating-point numbers, and so on. The EEW can represent an actual element width of data being processed, which can differ from the value specified in the VSEW field. In exemplary implementations, the EEW can vary between operations, such as loads, stores, or arithmetic instructions. This can enable an operating mode in which the data accessed in memory differs in width from the standard element width configured by the VSEW field. As an example, a load instruction can use an EEW specifying 8 bits, which specifies loading of individual bytes, while the VSEW for the vector operation can be configured for 32 bits, enabling processing of word-sized elements. This feature can enable flexibility, allowing a vector to process smaller data elements that are packed into a larger vector register.

The micro-operations sequencer 722 decomposes the high-level, architectural instruction into two first-level micro-operations, indicated at table 726. The first-level micro-operations can be VMMOs. The first VMMO 727 represents loading vector data from memory specified by registers R1 and R2 into physical register V1. Similarly, the second VMMO 729 represents loading vector data from memory specified by registers R1 and R2 into physical register V2.

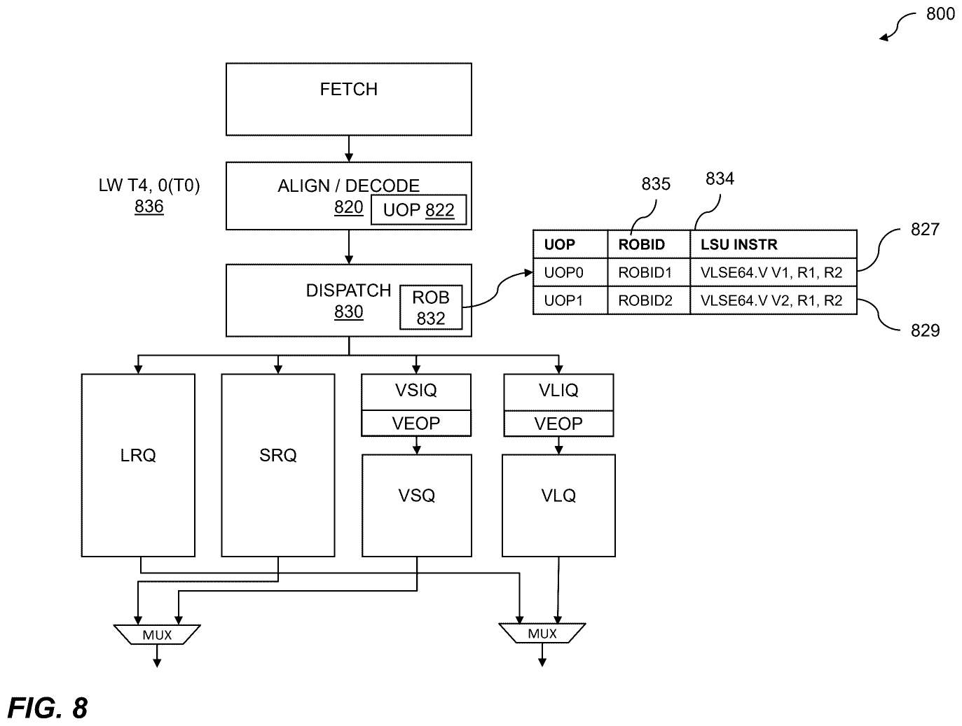

FIG. 8 is a second example of micro-element dispatch. The example 800 continues from example 700 of FIG. 7, and is also based on the block diagram for dispatching instructions shown in FIG. 6 and described previously. Accordingly, components in FIG. 8 are similar to counterpart components shown in FIG. 6. As shown in the example 800, the VMMOs 827 and 829 have advanced through the pipeline to the dispatch unit 830, providing capacity for scalar instruction 836 to advance to the align/decode unit 820. Since the scalar instruction is not a vector memory operation, it does not need to be broken up into VMMOs by the micro-operation sequencer 822. As can be seen in table 834, VMMO 827 and VMMO 829 are loaded into ROB 832, and accordingly, are each assigned a ROBID, indicated in column 835 of table 834. Accordingly, VMMO 827 is associated with ROBID1, and VMMO 829 is associated with ROBID2. Each ROBID can be associated with a slot or location in the ROB 832. In embodiments, the ROBID indicates an oldest entry within the plurality of memory queues.

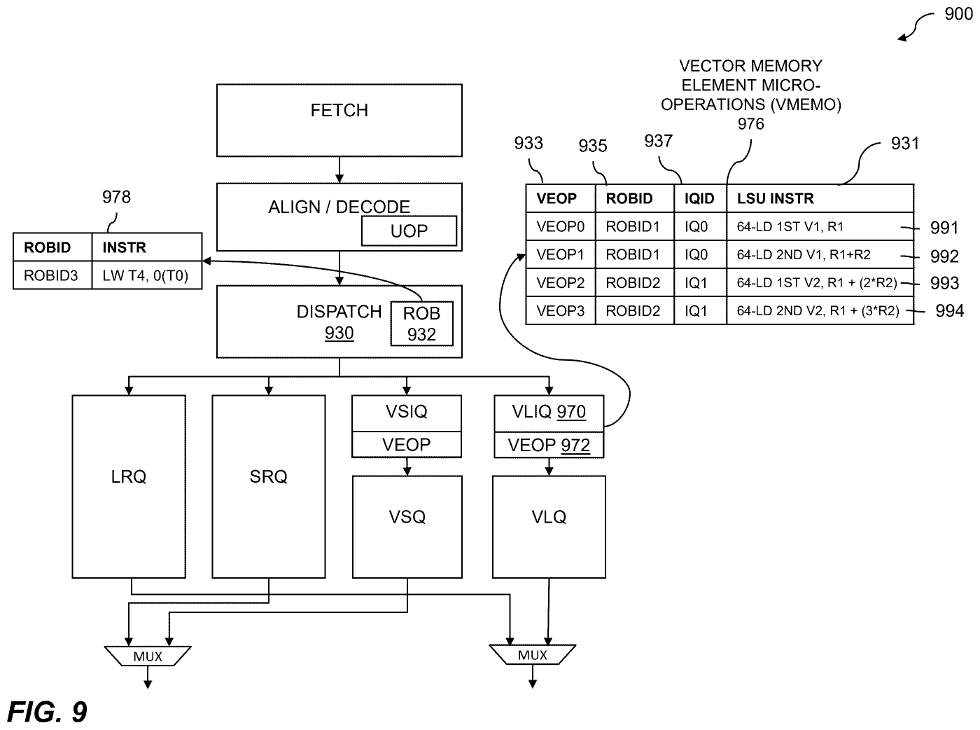

FIG. 9 is a third example of micro-element dispatch. The example 900 continues from example 800 of FIG. 8, and is also based on the block diagram for dispatching instructions shown in FIG. 6 and described previously. Accordingly, components in FIG. 9 are similar to counterpart components shown in FIG. 6. As shown in the example 900, VMMO 827 and VMMO 829 of FIG. 8 have been decomposed into second-level micro-operations, which are referred to as vector element micro-operations (VMEMOs), and shown in table 976. The column 931 shows four VMEMOs. Column 935 shows a corresponding ROBID for each VMEMO.

Another data field, the instruction queue identifier (IQID), is indicated at column 937. Column 933 indicates a vector element micro-operation identifier. As can be seen in table 976, each VMMO from FIG. 8 is decomposed into two VMEMOs. Accordingly, there are now four VMEMOs. Referring again to column 935, the first two ROBID values in column 935, corresponding to row 991 and row 992, indicate ROBID1, and the second two ROBID values in column 935, corresponding to row 993 and row 994, indicate ROBID2. Similarly, referring to column 937, the first two IQID values in column 937, corresponding to row 991 and row 992, have a value of IQ0, and the second two IQID values in column 937, corresponding to row 993 and row 994, have a value of IQ1. Accordingly, in exemplary implementations, there can be a 1:1 correspondence between ROBID value and IQID value. The VMEMOs are input to vector load instruction queue (VLIQ) 970, and then input to vector element micro-operation sequencer (VEOP) 972. In exemplary implementations, the IQID can be accessible from within the vector element micro-operation sequencer 972, enabling correlation of each VMEMO to a given VMMO, and thus, to a given ROBID within ROB 932. When all the VMEMOs corresponding to a given IQID have been completed, the corresponding ROBID can be freed to accept subsequent instructions and/or micro-operations. When a VMEMO completes, it can be updated in the VLIQ or the VSIQ. The updating can be based on the IQID associated with the VMEMO. The updating can also be based on an element ID (not shown). The element ID and the IQID can be used to determine the location within the input queue of the VMEMO that completed without having to perform a lookup. When all of the VMEMOs associated with a VMMO have completed, the VMMO can be retired by the ROB.

In the example 900, the scalar instruction indicated at table 978 has now moved to the dispatch unit 930. As indicated at table 978, the scalar instruction is associated with ROBID3. Accordingly, by transferring the vector operations out of dispatch unit 930 and into vector load instruction queue 970, the dispatch unit 930 has available capacity to process subsequent instructions, thereby improving overall instruction throughput and increasing processor performance.

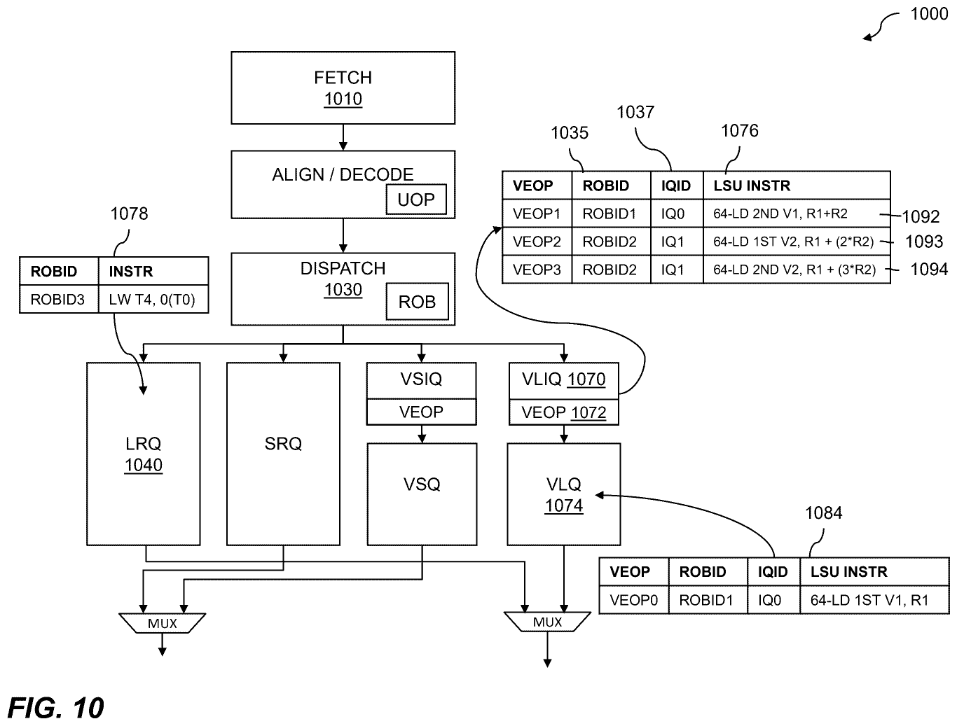

FIG. 10 is a fourth example of micro-element dispatch. The example 1000 continues from example 900 of FIG. 9, and is also based on the block diagram for dispatching instructions shown in FIG. 6 and described previously. Accordingly, components in FIG. 10 are similar to counterpart components shown in FIG. 6. As shown in the example 1000, the first VMEMO (indicated at row 991 of FIG. 9) is transferred to vector load queue 1074, as indicated in table 1084. VMEMOs remaining in the vector load instruction queue 1070 are indicated in table 1076. Accordingly, three VMEMOs currently remain in the VLIQ 1070, indicated at row 1092, row 1093, and row 1094. The scalar instruction as shown in table 1078 has transitioned from dispatch (shown at 978 in FIG. 9) to scalar load request queue (LRQ) 1040. In exemplary implementations, the ROBID corresponding to a first-level micro-operation (VMMO) is considered occupied until the vector instructions corresponding to the VMMO are retired. The IQID indicated in column 1037 enables the VEOP 1072 and/or VLQ 1074 to keep track of the second-level micro-operations and indicate to the dispatch unit 1030 when the ROBID, as shown in column 1035, may be safely relinquished to be made available to subsequent instructions that may be fetched by fetch unit 1010.

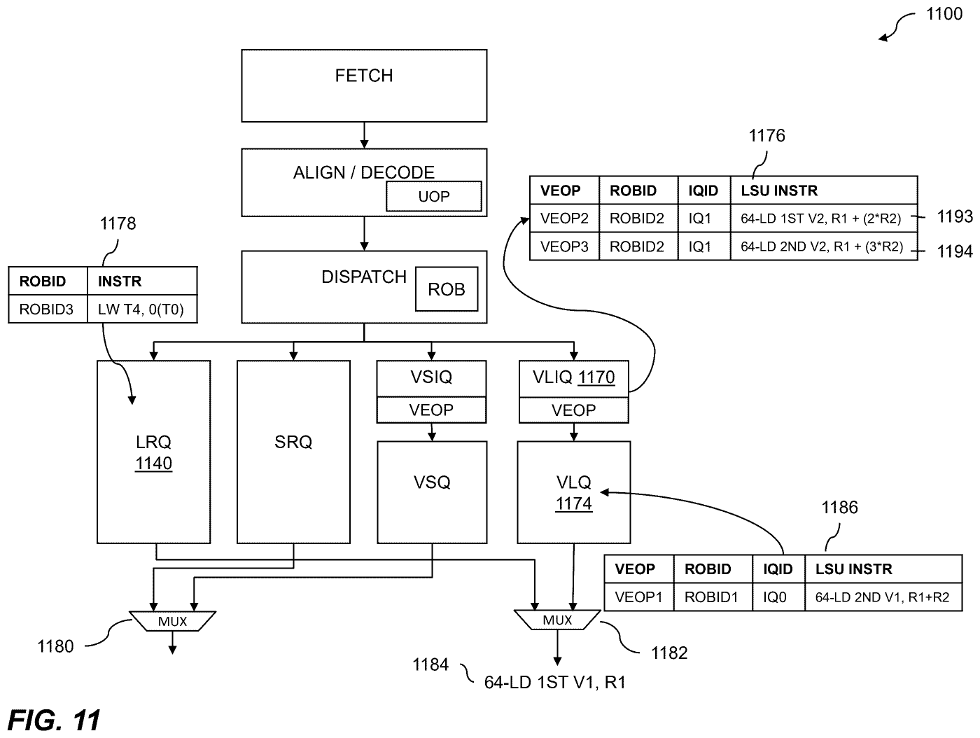

FIG. 11 is a fifth example of micro-element dispatch. The example 1100 continues from example 1000 of FIG. 10, and is also based on the block diagram for dispatching instructions shown in FIG. 6 and described previously. Accordingly, components in FIG. 11 are similar to counterpart components shown in FIG. 6. As shown in the example 1100, the VMEMO indicated at 1084 in FIG. 10 is now output to a downstream load/store unit (not shown), and the VMEMO is output from mux 1182, as indicated at 1184. The VMEMO indicated at row 1092 from FIG. 10 is loaded into VLQ 1174, as indicated by table 1186. The VMEMO in row 1193 and the VMEMO in row 1194 in table 1176 remain in the VLIQ 1170 at this stage. The scalar instruction 1178 continues to reside in LRQ 1140, based on ROBID. Once the high-level, architectural vector instruction (i.e., 712 of FIG. 7) is completed, the scalar instruction 1178 may be output from mux 1180 and sent downstream for further processing, execution, and the like.

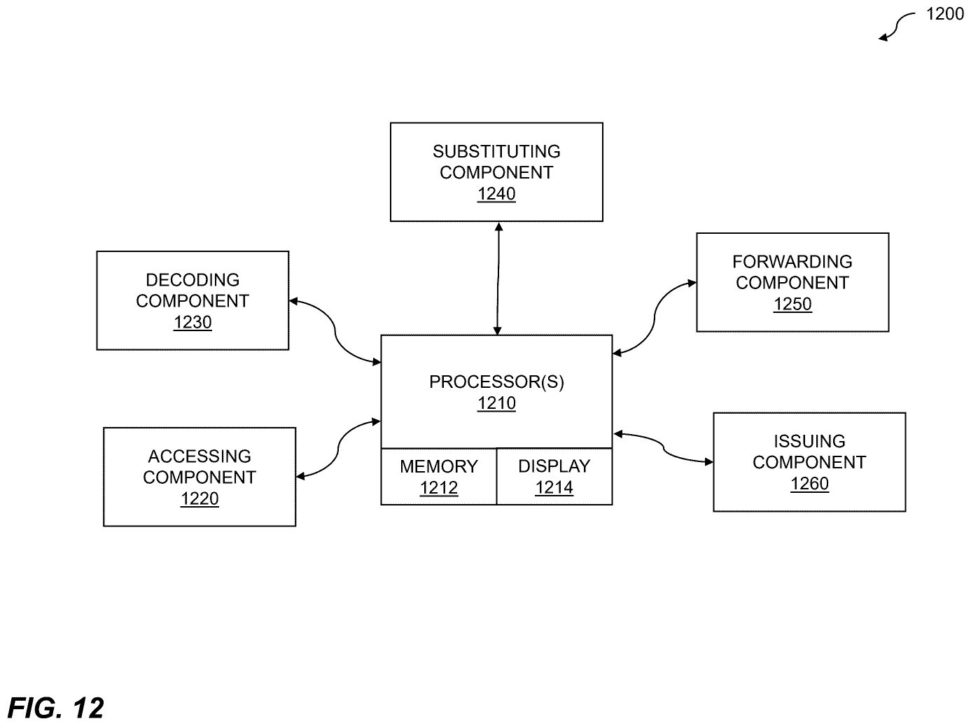

FIG. 12 is a system diagram for non-blocking vector instruction dispatch with micro-operations. The system 1200 can include instructions and/or functions for design, generation of semiconductor logic for, and implementation of integrated circuits that support vector memory operations with multiple levels of micro-operations. The system 1200 can include instructions and/or functions for generation and/or manipulation of design data such as hardware description language (HDL) constructs for specifying structure and operation of an integrated circuit. The system 1200 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 1200 can include one or more processors 1210. The processors can include standalone processors, processors within integrated circuits or chips, processor cores in FPGAs or ASICs, and so on. The one or more processors 1210 are coupled to a memory 1212, which stores instructions. The memory can include one or more of local memory, cache memory, system memory, etc. The system 1200 can further include a display 1214 coupled to the one or more processors 1210. The display can be used for displaying data, instructions, operations, micro-operations, VMMOs, VMEMOs, and the like. The operations can include instructions and functions for implementation of integrated circuits, including processor cores. In exemplary implementations, the processor cores can include RISC-V™ processor cores. A system comprising the one or more processors, when executing the instructions which are stored in the memory, is configured to enable non-blocking vector instruction dispatch with micro-element operations.

The system 1200 can include an accessing component 1220. The accessing component can include functions and instructions for accessing a processor core, wherein the processor core is coupled to a memory hierarchy, and wherein the processor core is configured to execute vector operations, scalar operations, and micro-operations. The processor core can include an ARM core, a MIPS core, and/or other suitable core type. In one or more exemplary implementations, the processor core can include a RISC-V architecture. The processor core can support vector operations. The RISC-V architecture can include extensions, where the extensions can enable execution of various arithmetic and logic operations. In exemplary implementations, a RISC-V architecture can include vector extensions. In exemplary implementations, the vector extensions can include VSEW, EEW, and VLM components, as detailed earlier. The processor core can include an execution pipeline, where the execution pipeline is configured to execute micro-operations. The micro-operations can include accessing a vector register, a starting address for data, a source register, a destination register, and so on.

The system 1200 can include a decoding component 1230. The decoding component can include functions and instructions for decoding, by a decode unit, a vector memory operation, wherein the vector memory operation is associated with a unit stride, constant stride, or indexed stride addressing mode. The decoding can include translating binary instruction codes into control signals and control fields needed for execution, and can also identify and retrieve operands from registers based on the instruction.

The system 1200 can include a substituting component 1240. The substituting component can include functions and instructions for substituting the one or more VMMOs with one or more vector memory element micro-operations (VMEMOs), wherein the substituting is based on the memory addressing mode. The system 1200 can include a forwarding component 1250. The forwarding component can forward at least one VMEMO within the one or more VMEMOs to a memory queue within a plurality of memory queues. In exemplary implementations, the VMEMO can include one or more micro-operations for a load instruction or a store instruction. The system 1200 can include an issuing component 1260. The issuing component can include functions and instructions for issuing, to a load-store unit within the processor core, a memory operation, wherein the issuing includes selecting, from the plurality of memory queues, the memory operation.

The system 1200 can include a computer program product embodied in a non-transitory computer readable medium, the computer program product comprising code which causes one or more processors to generate semiconductor logic for: accessing a processor core, wherein the processor core is configured to execute vector instructions, scalar instructions, and micro-operations; decoding a vector memory instruction, wherein the vector memory instruction is associated with a memory addressing mode, and wherein the decoding includes replacing the vector memory instruction with one or more vector memory micro-operations (VMMOs); substituting the one or more VMMOs with one or more vector memory element micro-operations (VMEMOs), wherein the substituting is based on the memory addressing mode; forwarding at least one VMEMO within the one or more VMEMOs to a memory queue within a plurality of memory queues; and issuing, to a load-store unit within the processor core, a memory operation, wherein the issuing includes selecting, from the plurality of memory queues, the memory operation.

The system 1200 can include a computer system for vector processing comprising: a memory which stores instructions; one or more processors coupled to the memory, wherein the one or more processors, when executing the instructions which are stored, are configured to: access a processor core, wherein the processor core is configured to execute vector instructions, scalar instructions, and micro-operations; decode a vector memory instruction, wherein the vector memory instruction is associated with a memory addressing mode, and wherein the decoding includes replacing the vector memory instruction with one or more vector memory micro-operations (VMMOs); substitute the one or more VMMOs with one or more vector memory element micro-operations (VMEMOs), wherein the substituting is based on the memory addressing mode; forward at least one VMEMO within the one or more VMEMOs to a memory queue within a plurality of memory queues; and issue, to a load-store unit within the processor core, a memory operation, wherein the issuing includes selecting, from the plurality of memory queues, the memory operation.

As can now be appreciated, disclosed implementations enable vector memory instructions to be dispatched and queued by decomposing high-level architectural vector memory instructions into VMMOs, and in turn decomposing each VMMO into multiple VMEMOs, thereby breaking complex instructions into smaller micro-instructions that allow the instruction pipeline to execute multiple micro-ops simultaneously across different stages. The multiple levels of micro-operations can enhance throughput by taking advantage of independent operations within a single high-level instruction, enabling out-of-order execution where possible.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products, processor-implemented methods, and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for vector processing comprising:
accessing a processor core, wherein the processor core is configured to execute vector instructions, scalar instructions, and micro-operations;
decoding a vector memory instruction, wherein the vector memory instruction is associated with a memory addressing mode, and wherein the decoding includes replacing the vector memory instruction with one or more vector memory micro-operations (VMMOs);
substituting the one or more VMMOs with one or more vector memory element micro-operations (VMEMOs), wherein the substituting is based on the memory addressing mode;
forwarding at least one VMEMO within the one or more VMEMOs to a memory queue within a plurality of memory queues; and
issuing, to a load-store unit within the processor core, a memory operation, wherein the issuing includes selecting, from the plurality of memory queues, the memory operation.

2. The method of claim 1 wherein the replacing is based on a micro-operation sequencer.

3. The method of claim 2 further comprising determining one or more destination registers for the vector memory instruction.

4. The method of claim 3 wherein the determining is based on a vector length multiplier (VLM).

5. The method of claim 1 wherein the substituting includes sending the one or more VMMOs to a vector input queue within a plurality of vector input queues.

6. The method of claim 5 wherein substituting is accomplished by a vector element micro sequencer.

7. The method of claim 6 wherein the vector element micro sequencer is located in the vector input queue.

8. The method of claim 7 wherein the vector memory instruction comprises a vector load instruction.

9. The method of claim 8 wherein the vector input queue comprises a vector load input queue (VLIQ).

10. The method of claim 9 wherein the memory queue comprises a vector load queue (VLQ).

11. The method of claim 10 wherein the plurality of memory queues includes a scalar load request queue (LRQ).

12. The method of claim 11 wherein the selecting comprises choosing between a scalar load instruction within the LRQ and the at least one VMEMO within the VLQ.

13. The method of claim 12 wherein the choosing is based on a reorder buffer identification (ROBID).

14. The method of claim 7 wherein the vector memory instruction comprises a vector store instruction.

15. The method of claim 14 wherein the vector input queue comprises a vector store input queue (VSIQ).

16. The method of claim 15 wherein the memory queue comprises a vector store queue (VSQ).

17. The method of claim 16 wherein the plurality of memory queues includes a scalar store request queue (SRQ).

18. The method of claim 17 wherein the selecting comprises selecting between a scalar store instruction within the SRQ and the at least one VMEMO within the VSQ.

19. The method of claim 18 wherein the selecting is based on a reorder buffer identification (ROBID).

20. The method of claim 1 further comprising associating a reorder buffer ID (ROBID) with the one or more VMMOs.

21. The method of claim 20 further comprising linking an input queue ID (IQID) with the one or more VMEMOs.

22. A computer program product embodied in a non-transitory computer readable medium for vector processing, the computer program product comprising code which causes one or more processors to generate semiconductor logic for:
accessing a processor core, wherein the processor core is configured to execute vector instructions, scalar instructions, and micro-operations;
decoding a vector memory instruction, wherein the vector memory instruction is associated with a memory addressing mode, and wherein the decoding includes replacing the vector memory instruction with one or more vector memory micro-operations (VMMOs);
substituting the one or more VMMOs with one or more vector memory element micro-operations (VMEMOs), wherein the substituting is based on the memory addressing mode;
forwarding at least one VMEMO within the one or more VMEMOs to a memory queue within a plurality of memory queues; and
issuing, to a load-store unit within the processor core, a memory operation, wherein the issuing includes selecting, from the plurality of memory queues, the memory operation.

23. A computer system for vector processing comprising:
a memory which stores instructions;
one or more processors coupled to the memory, wherein the one or more processors, when executing the instructions which are stored, are configured to:
access a processor core, wherein the processor core is configured to execute vector instructions, scalar instructions, and micro-operations;
decode a vector memory instruction, wherein the vector memory instruction is associated with a memory addressing mode, and wherein the decoding includes replacing the vector memory instruction with one or more vector memory micro-operations (VMMOs);
substitute the one or more VMMOs with one or more vector memory element micro-operations (VMEMOs), wherein the substituting is based on the memory addressing mode;
forward at least one VMEMO within the one or more VMEMOs to a memory queue within a plurality of memory queues; and
issue, to a load-store unit within the processor core, a memory operation, wherein the issuing includes selecting, from the plurality of memory queues, the memory operation.
